(19) United States
(12) Patent Application Publication
(10) Pub. No.: US 2015/0138192 A1
(43) Pub. Date: May 21, 2015

(54) METHOD FOR PROCESSING 3D OBJECT AND ELECTRONIC DEVICE THEREOF

(71) Applicant: Samsung Electronics Co., Ltd., Gyeonggi-do (KR)

(72) Inventors: Andrey Marchenko, Kyiv (UA); Vitaliy Solopan, Kiev (UA); Oleksandr Maliuk, Kyiv (UA)

(21) Appl. No.: 14/546,950

(22) Filed: Nov. 18, 2014

(30) Foreign Application Priority Data
Nov. 18, 2013 (KR) 10-2013-0140009

(51) Int. Cl. G06T 19/20

(52) U.S. Cl. CPC G06T 19/20; G06T 2200/24; G06T 2219/2016; G06T 2219/2004
USPC 345/419

(57) ABSTRACT

A device and method for editing a 3D object in an electronic device is provided. An operation of the electronic device includes displaying a 3D object. The operation of the electronic device also includes deactivating at least one of a plurality of editing functions for the displayed 3D object. The operation of the electronic device further includes editing the displayed 3D object using an editing function activated on the basis of input information.

### PRIORITY

The present application is related to and claims priority under 35 U.S.C. §119 to an application filed in the Korean Intellectual Property Office on Nov.18, 2013 and assigned Serial No. 10-2013-0140009, the contents of which are incorporated herein by reference.

### TECHNICAL FIELD

Various embodiments of the present disclosure relate to a device and method for editing a 3D object in an electronic device.

### BACKGROUND

As the use of multimedia services in mobile electronic devices increases, the amount of information to be processed or displayed by the mobile electronic devices increases. Accordingly, an electronic device provided with a touch screen for increasing the size of a display unit through improvement of space utilization has been attracted attention.

A touch screen is an input or output device which enables both input and display of information. Therefore, an additional input device such as a keypad may not be provided to an electronic device employing a touch screen, and thus, a display area of the electronic device may be increased.

Although the display area may be increased using a touch screen, the increase of the display area is limited since the portability of a mobile electronic device should be considered. Due to such limitation, a user may feel inconvenience when editing an object displayed on a display unit of a mobile electronic device.

### SUMMARY

To address the above-discussed deficiencies, it is a primary object toprovide a device and method for editing an object (such as a 3D object) displayed on a display area in a mobile electronic device.

The various embodiments of the present disclosure provide a device and method for activating or deactivating at least one of editing functions for editing a 3D object displayed on a display area in a mobile electronic device.

The various embodiments of the present disclosure provide a device and method for inactivating at least one of editing functions for editing a 3D object displayed on a display area on the basis of an event characteristic in a mobile electronic device.

In a first embodiment, a method for operating an electronic device is provided. The method includes displaying a 3D object. The method also includes deactivating at least one of a plurality of editing functions for the displayed 3D object. The method further includes editing the displayed 3D object using an editing function activated on the basis of input information.

In a second embodiment, an electronic device is provided. The electronic device includes an input unit. The electronic device also includes a display unit configured to display a 3D object. The electronic device further includes a processor configured to deactivate at least one of a plurality of editing functions for the 3D object displayed on the display unit, and edit the 3D object displayed on the display unit using an editing function activated on the basis of input information detected through the input unit.

Other aspects, advantages, and salient features of the disclosure will become apparent to those skilled in the art from the following detailed description, which, taken in conjunction with the annexed drawings, discloses exemplary embodiments of the disclosure.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 is a block diagram illustrating an example electronic device according to this disclosure;

FIG. 2 is a block diagram illustrating an example processor according to this disclosure;

FIG. 3 is a flowchart illustrating an example procedure of deactivating at least one editing function in the electronic device according to this disclosure;

FIG. 4 is a flowchart illustrating an example procedure of deactivating at least one editing function on the basis of an event characteristic in an electronic device according to this disclosure;

FIGS. 5A, 5B, and 5C are diagrams illustrating an example screen configuration for resizing a 3D object in the electronic device according to this disclosure;

FIGS. 6A and 6B are diagrams illustrating an example screen configuration for moving a 3D object in the electronic device according to this disclosure;

FIGS. 7A, 7B, and 7C are diagrams illustrating an example screen configuration for changing a display direction of a 3D object in the electronic device according to this disclosure;

FIG. 8 is a flowchart illustrating an example procedure of editing at least one of 3D objects displayed on a display area in the electronic device according to this disclosure;

FIGS. 9A, 9B, and 9C are diagrams illustrating an example screen configuration for changing a display direction of at least one of 3D objects displayed on a display area in the electronic device according to this disclosure;

FIG. 10 is a flowchart illustrating an example procedure of deactivating at least one editing function in the electronic device according to this disclosure;

FIGS. 11A, 11B, 11C, and 11D are diagrams illustrating an example screen configuration for changing a display direction of a 3D object in the electronic device according to this disclosure;

FIG. 12 is a flowchart illustrating an example procedure of editing at least one of 3D objects displayed on a display area in the electronic device according to this disclosure; and

FIGS. 13A, 13B, 13C, and 13D are diagrams illustrating an example screen configuration for changing a display direction of at least one of 3D objects displayed on a display area in the electronic device according to this disclosure.

### DETAILED DESCRIPTION

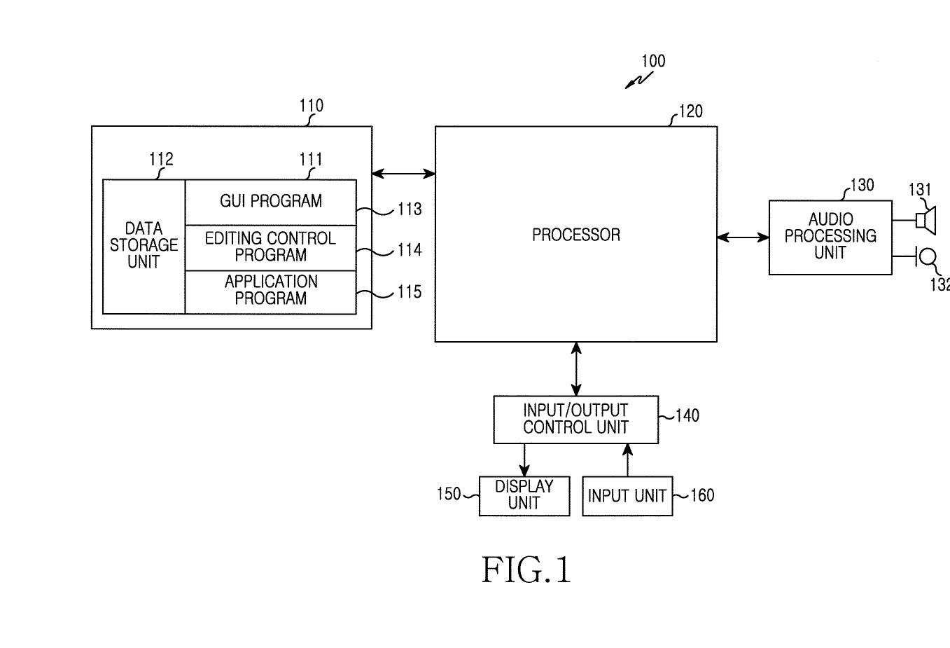

FIGS. 1 through 13D, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device. The following description with reference to the accompanying drawings is provided to assist in a comprehensive understanding of exemplary embodiments of the disclosure as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of exemplary embodiments of the present disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

Hereinafter, a technology for editing a 3D object in an electronic device according to various embodiments of the present disclosure will be described. Herein, the 3D object may include information displayed on a display unit of the electronic device in the form of at least one of a text, a table, and an image.

An electronic device according to the present disclosure may be any one or combination of various devices capable of displaying a 3D object, such as a smartphone, a tablet personal computer (PC), a mobile phone, a video phone, an electronic book reader, a desktop PC, a laptop PC, a netbook computer, a personal digital assistant (PDA), a portable multimedia player (PMP), an MP3 player, a mobile medical device, an accessory, an electronic appcessory, a camera, a wearable device, an electronic clock, a wrist watch, a refrigerator, an air conditioner, a cleaner, an artificial intelligence robot, a TV, a digital disk disc (DVD) player, an audio, an oven, a microwave oven, a washing machine, an electronic bracelet, an electronic necklace, an air cleaner, an electronic picture frame, a medical device (such as magnetic resonance angiography (MRA), magnetic resonance imaging (MRI) or computed tomography (CT) scanning machine, and an ultrasonic device), a navigation device, a GPS receiver, an event data recorder (EDR), a flight data recorder (FDR), a set-top box, a TV box (such as Samsung HomeSync™, Apple TV™, and Google TV™), an electronic dictionary, a vehicle infotainment device, electronic equipment for ship (such as a marine navigation device and a gyro compass), avionics, a security device, electronic clothes, an electronic key, a camcorder, a game console, a head-mounted display (HMD), a flat panel display device, an electronic album, a part of furniture or building/structure having electronic devices, an electronic board, an electronic signature receiving device, and a projector. It would be obvious to those skilled in the art that the electronic device according to the present disclosure is not limited to the above-mentioned devices.

In the following description, a function of editing a 3D object may include at least one of resizing the 3D object, changing a position of the 3D object, changing a camera shooting direction, and rotating the 3D object.

FIG. 1 is a block diagram illustrating an example electronic device according to this disclosure.

Referring to FIG. 1, an electronic device 100 may include a memory 110, a processor 120, an audio processing unit 130, an input/output control unit 140, a display unit 150, and an input device 160. Here, at least one of the memory 110 and the processor 120 may exist in plurality.

The memory 110 may include a data storage unit 111 for storing data generated while the electronic device 100 is driven and a program storage unit 112 for storing at least one program for controlling an operation of the electronic device 100.

The data storage unit 111 may include information on an editing function to be deactivated, the information being mapped to an event characteristic.

The program storage unit 112 may include a graphic user interface (GUI) program 113, an editing control program 114, and at least one application program 115. Here, the program stored in the program storage unit 112 is a set for instructions and may be referred to as an instruction set.

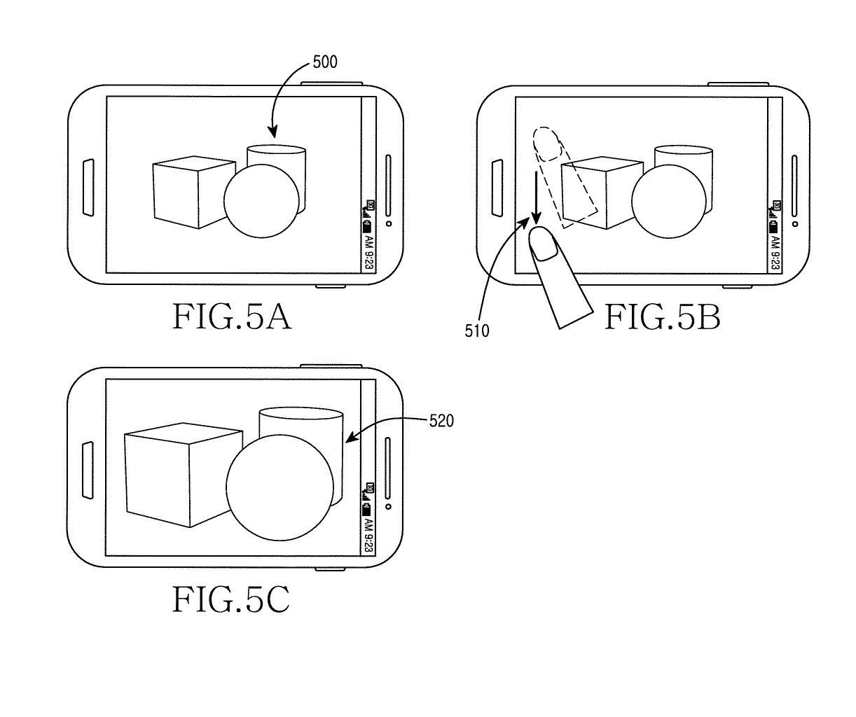

The GUI program 113 may include at least one software element for providing a graphic user interface on the display unit 150. Here, the GUI program 113 may allow information on an application program driven by the processor 120 to be displayed on the display unit 150. For example, the GUI program 113 may allow at least one 3D object 500 to be displayed on the display unit 150 according to control by the processor 120, as illustrated in FIG. 5A.

The GUI program 113 may include at least one software element for editing the object displayed on the display unit 150. Here, the GUI program 113 may edit the 3D object displayed on the display unit 150 on the basis of input information received through the input unit 160 and an editing function not deactivated by the editing control program 114. For example, when only an object resizing function is activated, the GUI program 113 may allow the 3D object displayed on the display unit 150 to be magnified (520) as illustrated in FIG. 5C, on the basis of a touch input 510 as illustrated in FIG. 5B.

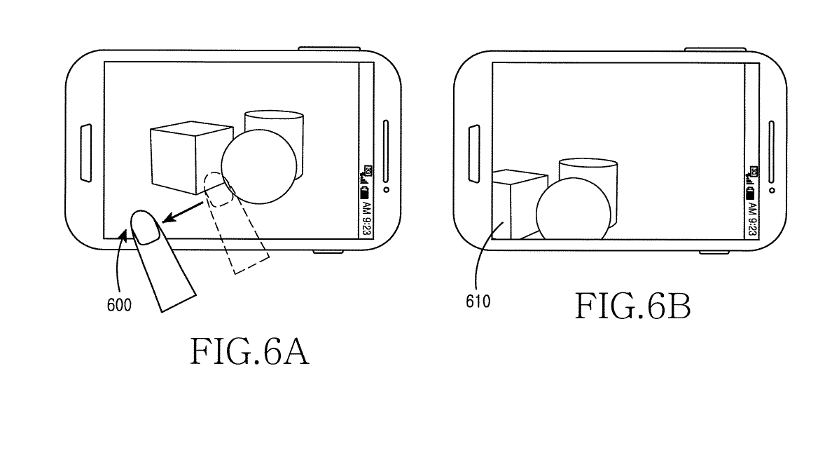

For another example, when only an object moving function is activated, the GUI program 113 may allow the 3D object displayed on the display unit 150 to be moved (610) as illustrated in FIG. 6B, on the basis of a touch input 600 as illustrated in FIG. 6A.

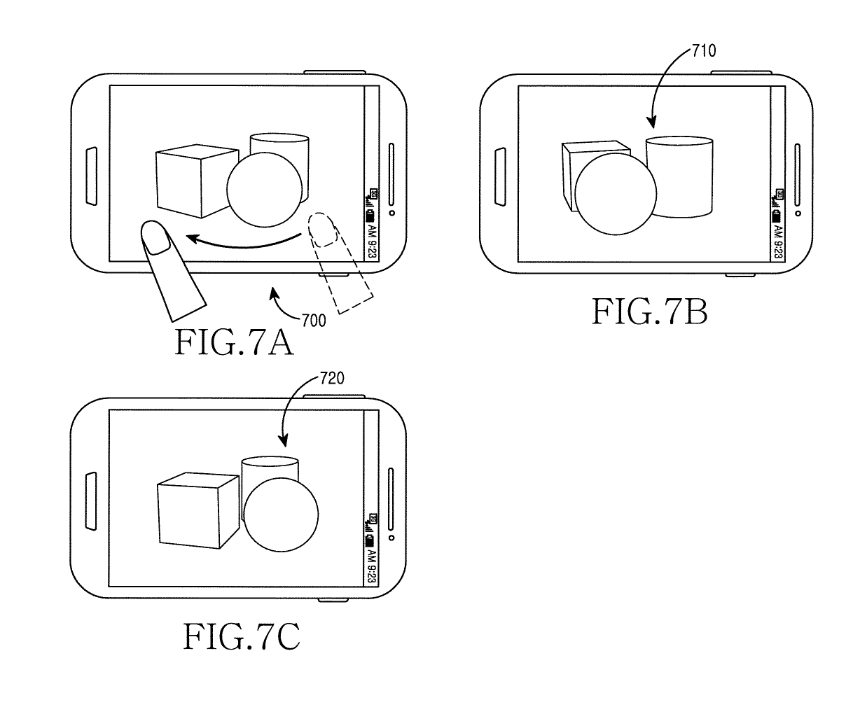

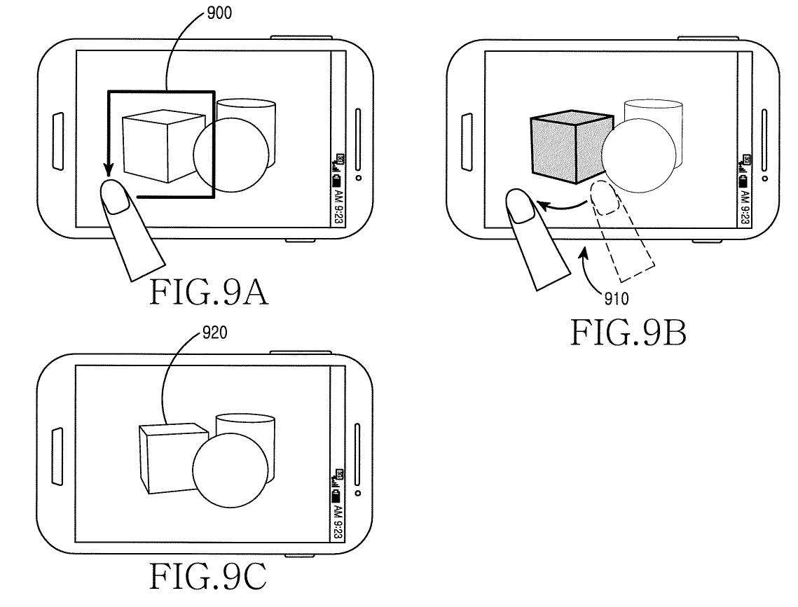

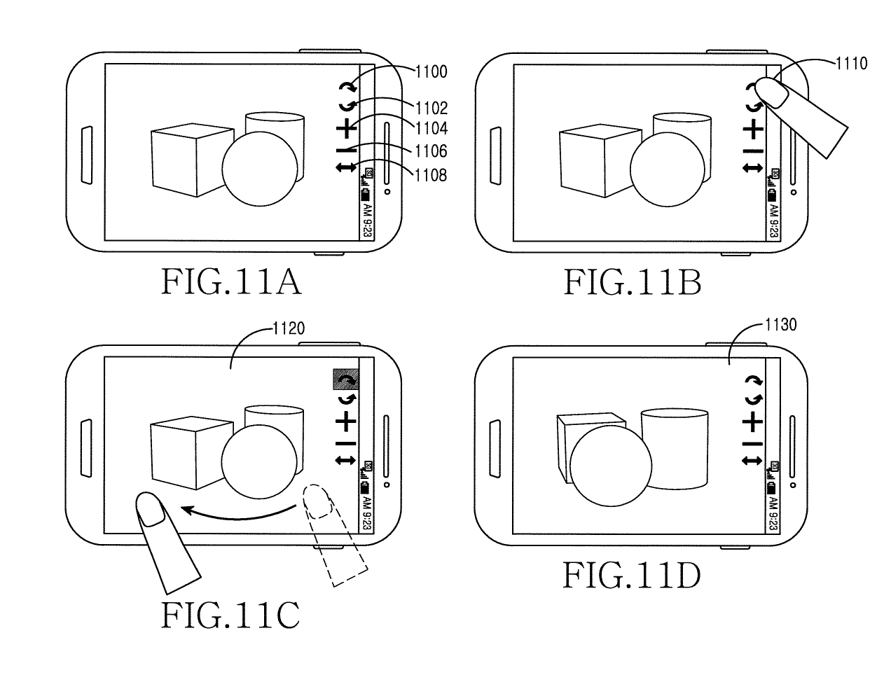

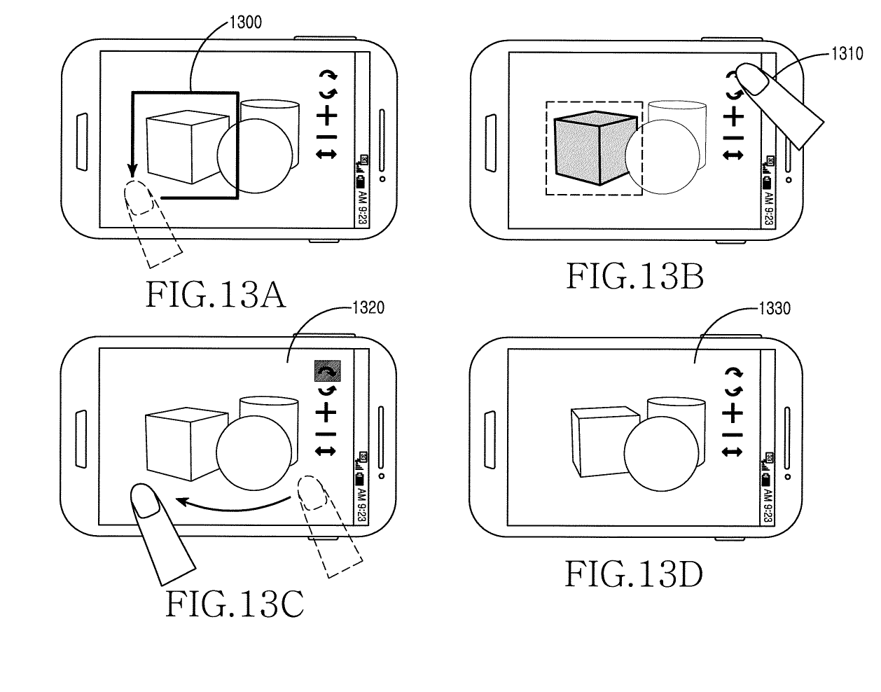

For another example, when only an object rotating function is activated, as illustrated in FIG. 7B or 11D, the GUI program 113 may allow the 3D object displayed on the display unit 150 to be rotated (710 or 1130) in the same direction as that of a touch input 700 or 1120 illustrated in FIG. 7A or 11C. Here, the GUI program 113 may allow at least one 3D object selected by the editing control program 114 from among a plurality of 3D objects displayed on the display unit 150 to be rotated (920 or 1330) in the same direction as that of a touch input 910 or 1320, as illustrated in FIG. 9A or 13A.

For another example, when only a camera moving function is activated, as illustrated in FIG. 7C, the GUI program 113 may allow the 3D object displayed on the display unit 150 to be rotated (720) in an opposite direction to that of the touch input 700 illustrated in FIG. 7A. That is, when a camera is moved, the camera is moved around the 3D object in the direction of the touch input 700, and thus, the GUI program 113 may rotate the 3D object in an opposite direction to that of the touch input 700.

The GUI program 114 may include at least one software element for determining an editing function to be applied to the 3D object displayed on the display unit 150. Here, the editing control program 114 may deactivate at least one of a plurality of editing functions that may be used to edit the 3D object in the GUI program 113. For example, when an editing function restricting event occurs, the editing control program 114 may deactivate at least one of the editing functions for editing the 3D object in the GUI program 113, on the basis of a characteristic of the editing function restricting event. For another example, when selection of a first editing icon is detected on the basis of the input information received through the input unit 160, the editing control program 114 may deactivate the editing functions for editing the 3D object in the GUI program 113 excepting at least one editing function mapped to the first editing icon.

The editing control program 114 may include at least one software element for determining an editing area to be edited on the basis of the input information received through the input unit 160. For example, the editing control program 114 may determine at least one 3D object 900 or 1300 from among the plurality of 3D objects displayed on the display unit 150 as the editing area on the basis of the touch input 910 or 1320 detected through the input unit 160 as illustrated in FIG. 9A or 13A.

The application program 115 may include a software element for at least one application program installed in the electronic device 100.

The processor 120 may use at least one program stored in the memory 110 so that the electronic device 100 provides various multimedia services. Here, the processor 120 may execute the editing control program 114 stored in the program storage unit 112 so as to determine an editing function to be applied to the 3D object displayed on the display unit 150. That is, the processor 120 may deactivate at least one editing function to be restricted from among the editing functions that can be used to edit the 3D object display on the display unit 150. For example, when the editing function restricting event occurs, the processor 120 may deactivate at least one of the editing functions for editing the 3D object displayed on the display unit 150, on the basis of the characteristic of the editing function restricting event. For another example, when selection of the first editing icon from among editing icons displayed on the display unit 150 is detected on the basis of the input information received through the input unit 160, the processor 120 may deactivate the editing functions for editing the 3D object displayed on the display unit 150 excepting at least one editing function mapped to the first editing icon.

The processor 120 may execute the editing control program 114 so as to determine the editing area to be edited on the basis of the input information received through the input unit 160. For example, the processor 120 may determine at least one 3D object 900 or 1300 from among the plurality of 3D objects displayed on the display unit 150 as the editing area on the basis of the touch input 910 or 1320 detected through the input unit 160 as illustrated in FIG. 9A or 13A.

The processor 120 may execute the GUI program 113 stored in the program storage unit 112 so as to edit the 3D object displayed on the display unit 150 on the basis of the input information received through the input unit 160 and an activated editing function.

The audio processing unit 130 may provide an audio interface between a user and the electronic device 100 through a speaker 131 and a microphone 132.

The input/output control unit 140 may provide an interface between the processor 120 and an input/output device such as the display unit 150 and the input unit 160.

The display unit 150 may display state information of the electronic device 100, a character input by a user, a moving picture or a still picture. Here, the display unit 150 may display information on an application run by the processor 120. For example, the display unit 150 may display at least one 3D object 500 according to control by the processor 120, as illustrated in FIG. 5A. Here, the display unit 150 may also display editing information of the 3D object according to control by the processor 120.

The input unit 160 may provide input data generated due to selection by a user to the processor 120 via the input/output control unit 140. For example, the input unit 160 may include at least one of a keypad including at least one hardware button and a touchpad for detecting touch information.

A communication system for performing at least one of voice communication and data communication may be included in the electronic device 100. For example, the communication system may support a short-range communication protocol (such as wireless fidelity (Wi-Fi), Bluetooth (BT) or near field communication (NFC)) or network communication (such as Internet, local area network (LAN), wide area network (WAN), telecommunication network, cellular network, satellite network or plain old telephone service (POTS)).

In the above-mentioned embodiment, the processor 120 may execute software elements stored in the program storage unit 112 within a single module so as to determine an editing function for editing the 3D object displayed on the display unit 150.

In another embodiment, the processor 120 may be configured so that the elements for determining an editing function for the 3D object displayed on the display unit 150 are included as separate modules.

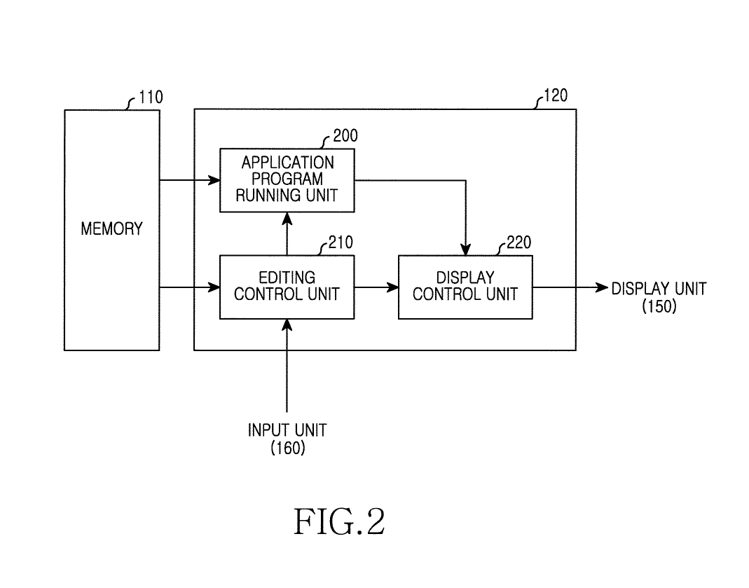

FIG. 2 is a block diagram illustrating an example processor according to this disclosure.

Referring to FIG. 2, the processor 120 may include an application program running module 200, an editing control module 210, and a display control module 220.

The application program running module 200 may execute at least one application program 115 stored in the program storage unit 112 so as to provide a service according to the application program. For example, the application program running module 200 may provide a service according to an application program for displaying a 3D object.

The editing control module 210 may determine an editing function to be applied to the 3D object displayed on the display unit 150. Here, the editing control module 210 may execute the editing control program 114 stored in the program storage unit 112 so as to determine an editing function to be applied to the 3D object. That is, the editing control module 210 may deactivate at least one of the editing functions that can be used to edit the 3D object in the display control module 220. For example, when the editing function restricting event occurs, the editing control module 210 may deactivate at least one editing function mapped to the characteristic of the editing function restricting event. For another example, when selection of the first editing icon is detected on the basis of the input information received through the input unit 160, the editing control module 210 may deactivate the editing functions excepting at least one editing function mapped to the first editing icon.

The editing control module 210 may determine an editing area to be edited on one or more 3D objects displayed on the display unit 150. For example, the editing control module 210 may determine at least one 3D object 900 or 1300 from among the plurality of 3D objects displayed on the display unit 150 as the editing area on the basis of the touch input 910 or 1320 detected through the input unit 160 as illustrated in FIG. 9A or 13A.

The display control module 220 may provide a graphic user interface on the display unit 150. Here, the display control module 220 may execute the GUI program 113 stored in the program storage unit 112 so as to provide the graphic user interface on the display unit 150. For example, the display control module 220 may allow at least one 3D object 500 to be displayed on the display unit 150 on the basis of an application program run by the application program running module 200, as illustrated in FIG. 5A.

The display control module 220 may execute the GUI program 113 so as to edit the object displayed on the display unit 150. Here, the display control module 220 may edit the 3D object displayed on the display unit 150 on the basis of the input information received through the input unit 160 and an editing function not deactivated by the editing control module 210. For example, when only the object resizing function is activated by the editing control module 210, the display control module 220 may allow the 3D object displayed on the display unit 150 to be magnified (520) as illustrated in FIG. 5C, on the basis of the touch input 510 as illustrated in FIG. 5B.

For another example, when only the object moving function is activated by the editing control module 210, the display control module 220 may allow the 3D object displayed on the display unit 150 to be moved (610) as illustrated in FIG. 6B, on the basis of the touch input 600 as illustrated in FIG. 6A.

For another example, when only the object rotating function is activated by the editing control module 210, as illustrated in FIG. 7B or 11D, the display control module 220 may allow the 3D object displayed on the display unit 150 to be rotated (710 or 1130) in the same direction as that of the touch input 700 or 1120 illustrated in FIG. 7A or 11C. Here, the display control module 220 may allow at least one 3D object selected by the editing control program 210 from among the plurality of 3D objects displayed on the display unit 150 to be rotated (920 or 1330) in the same direction as that of the touch input 910 or 1320 as illustrated in FIG. 9A or 13A.

For another example, when only the camera moving function is activated by the editing control module 210, the display control module 220 may allow the 3D object displayed on the display unit 150 to be rotated (720) in an opposite direction to that of the touch input 700 illustrated in FIG. 7A, as illustrated in FIG. 7C. That is, when a camera is moved, the camera is moved around the 3D object in the direction of the touch input 700, and thus, the display control module 220 may rotate the 3D object in an opposite direction to that of the touch input 700.

As described above, the electronic device 100 may deactivate an editing function not to be used so as to reduce an error of editing a 3D object when the 3D object displayed on the display unit 150 is edited on the basis of input information. For example, when the electronic device 100 detects an editing input for the 3D object through the input unit 160, the electronic device 100 is unable to distinguish moving, resizing and rotating of the 3D object through the editing input. Accordingly, the electronic device 100 may deactivate at least one editing function excepting an editing function for editing the 3D object so as to reduce the error of editing the 3D object, while enabling easy editing of the 3D object.

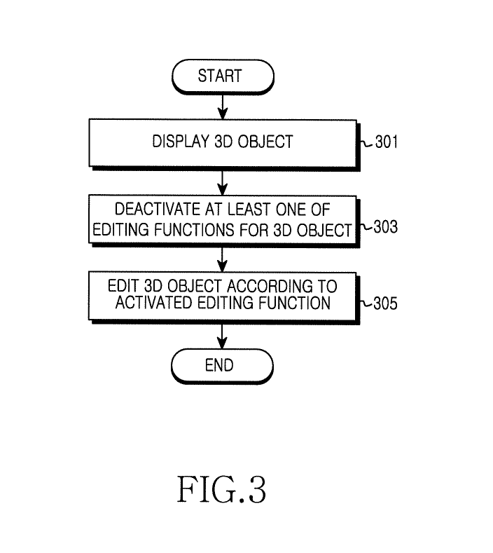

FIG. 3 is a flowchart illustrating an example procedure of deactivating at least one editing function in an electronic device according to this disclosure. Hereinafter, a procedure of editing a 3D object will be described with reference to FIGS. 5A to 5C, 6A, 6B, 7A to 7C, 9A, 9B, 11A to 11D and 13A to 13D.

Referring to FIG. 3, the electronic device may display a 3D object on the display unit 150 in operation 301. For example, when an application program for displaying a 3D object is run, the electronic device may display at least one 3D object 500 on the display unit 150 as illustrated in FIG. 5A.

When the 3D object is displayed, the electronic device may deactivate at least one of editing functions for the 3D object in operation 303. For example, when the 3D object displayed on the display unit 150 is desired to be rotated, the electronic device may perform a camera moving operation, which is not intended by a user, with respect to the 3D object since input information for rotating the 3D object is similar to that for moving a camera. Therefore, the electronic device may deactivate the camera moving function for the 3D object. For another example, when the 3D object displayed on the display unit 150 is desired to be rotated, the electronic device may deactivate one or more editing functions excepting the object rotating function.

When at least one editing function is deactivated, the electronic device may edit the 3D object displayed on the display unit 150 on the basis of an activated editing function in operation 305. For example, when the object resizing function is activated, the electronic device may magnify (520) the 3D object displayed on the display unit 150 as illustrated in FIG. 5C, on the basis of the touch input 510 as illustrated in FIG. 5B. For another example, when the object moving function is activated, the electronic device may move (610) the 3D object displayed on the display unit 150 as illustrated in FIG. 6B, on the basis of the touch input 600 as illustrated in FIG. 6A. For another example, when the object rotating function is activated, as illustrated in FIG. 7B or 11D, the electronic device may rotate (710 or 1130) the 3D object displayed on the display unit 150 in the same direction as that of the touch input 700 or 1120 illustrated in FIG. 7A or 11C. For another example, when the camera moving function is activated, as illustrated in FIG. 7C, the electronic device may rotate (720) the 3D object displayed on the display unit 150 in an opposite direction to that of the touch input 700 illustrated in FIG. 7A.

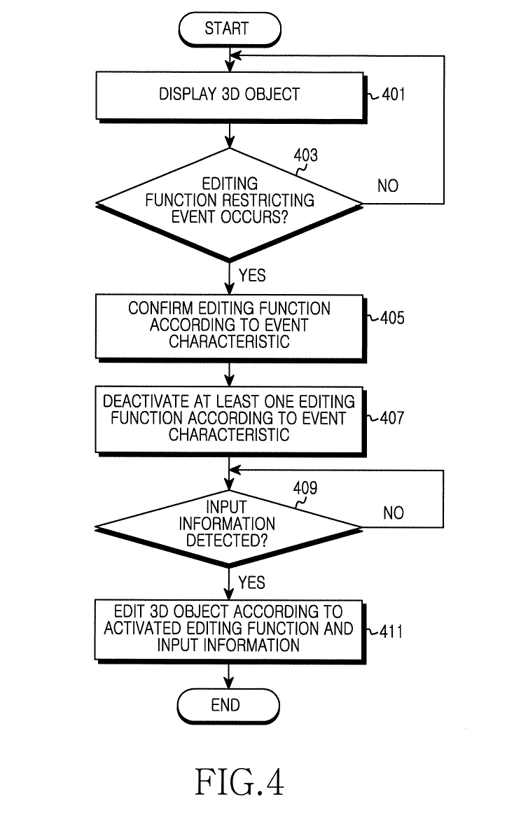

FIG. 4 is a flowchart illustrating an example procedure of deactivating at least one editing function on the basis of an event characteristic in an electronic device according to this disclosure. Hereinafter, a procedure of editing a 3D object will be described with reference to FIGS. 5A to 5C, 6A, 6B and 7A to 7C.

Referring to FIG. 4, the electronic device may display a 3D object on the display unit 150 in operation 401. For example, when an application program for displaying a 3D object is run, the electronic device may display at least one 3D object 500 on the display unit 150 as illustrated in FIG. 5A.

When the 3D object is displayed, the electronic device may determine whether an editing function restricting event occurs in operation 403. For example, the electronic device may determine whether an editing function restricting menu is selected. For another example, the electronic device may determine whether selection of an editing function restricting icon is detected. For another example, the electronic device may determine whether a gesture of the electronic device for restricting an editing function is detected. For another example, the electronic device may determine whether a hardware button input for restricting an editing function is detected.

When the editing function restricting event does not occur, the electronic device may maintain the displaying of the 3D object in operation 401. If the editing function restricting event does not occur for a reference time, the electronic device may terminate the present algorithm.

When the editing function restricting event occurs, the electronic device may identify at least one editing function to be inactivated on the basis of the event characteristic in operation 405. For example, when the editing function restricting event occurs, the electronic device may display an editing function list for the 3D object. Here, the electronic device may determine an editing function selected on the basis of the input information received through the input unit 160 as an editing function to be deactivated from among editing functions of the editing function list. For another example, when a first editing function restricting icon is selected from among editing function restricting icons displayed on the display unit 150, the electronic device may determine at least one editing function mapped to the first editing function restricting icon as an editing function to be deactivated. For another example, when a first gesture of the electronic device for restricting an editing function is detected, the electronic device may determine at least one editing function mapped to the first gesture as an editing function to be deactivated. For another example, when a hardware button input for restricting an editing function is detected, the electronic device may determine at least one editing function mapped to the detected hardware button input as an editing function to be deactivated.

The electronic device may deactivate at least one editing function according to the event characteristic in operation 407.

When at least one editing function is deactivated, the electronic device may determine whether the input information is detected through the input unit 160 in operation 409. That is, the electronic device may determine whether a user input for editing a 3D object is detected through the input unit 160.

When the input for editing a 3D object is detected, the electronic device may edit the 3D object displayed on the display unit 150 on the basis of an activated editing function and the input information in operation 411. For example, when the object resizing function is activated, the electronic device may magnify (520) the 3D object displayed on the display unit 150 as illustrated in FIG. 5C, on the basis of the touch input 510 that moves downward as illustrated in FIG. 5B. The 3D object displayed on the display unit 150 may be reduced by the electronic device when a touch input that moves upward is detected. Here, the electronic device may magnify or reduce the 3D object in proportion to a moving distance of the touch input. For another example, when the object resizing function is activated, the electronic device may magnify or reduce the 3D object displayed on the display unit 150 on the basis of the movement of the touch input with respect to the vertices of the 3D object. Here, the electronic device may magnify or reduce the 3D object in proportion to a moving distance of the touch input. For another example, when the object moving function is activated, the electronic device may move (610) the 3D object displayed on the display unit 150 as illustrated in FIG. 6B, on the basis of the touch input 600 as illustrated in FIG. 6A. Here, the electronic device may move the 3D object in proportion to a moving distance of the touch input. For another example, when the object rotating function is activated, as illustrated in FIG. 7B, the electronic device may rotate (710) the 3D object displayed on the display unit 150 in the same direction as that of the touch input 700 illustrated in FIG. 7A. For another example, when the camera moving function is activated, as illustrated in FIG. 7C, the electronic device may rotate (720) the 3D object displayed on the display unit 150 in an opposite direction to that of the touch input 700 illustrated in FIG. 7A.

As described above, the electronic device may deactivate an editing function not to be used so as to reduce an error of editing a 3D object when the 3D object displayed on the display unit 150 is edited on the basis of the input information. For example, the electronic device may resize the 3D object on the basis of the movement of the touch input with respect to the vertices of the 3D object, or rotate the 3D object on the basis of the movement of the touch input outside the 3D object. Although a user provides a touch input to an edge of the 3D object in order to resize the 3D object, the electronic device may be unable to correctly determine the touch point on the 3D object. In this case, the electronic device may be unable to clearly distinguish the resizing of the 3D object and the rotating of the 3D object on the basis of the touch input, causing an editing error. Therefore, the electronic device 100 may deactivate the 3D object rotating function to resize the 3D object without the editing error.

In the above-mentioned embodiment, at least one editing function may be deactivated on the basis of the editing function restricting event. Here, when an editing function activating event occurs, the electronic device may activate the editing function deactivated due to the editing function restricting event. For example, when the editing function restricting function occurs repeatedly, the electronic device may recognize that the editing function activating event has occurred so as to activate the deactivated editing function. For another example, when a 3D object is edited after at least one editing function is deactivated due to the editing function restricting event, the electronic device may recognize that the editing function activating event has occurred so as to activate the deactivated editing function. For another example, the electronic device may determine whether an editing function activating menu is selected. For another example, the electronic device may determine whether selection of an editing function activating icon is detected. For another example, the electronic device may determine whether a gesture of the electronic device for activating an editing function is detected. For another example, the electronic device may determine whether a hardware button input for activating an editing function is detected.

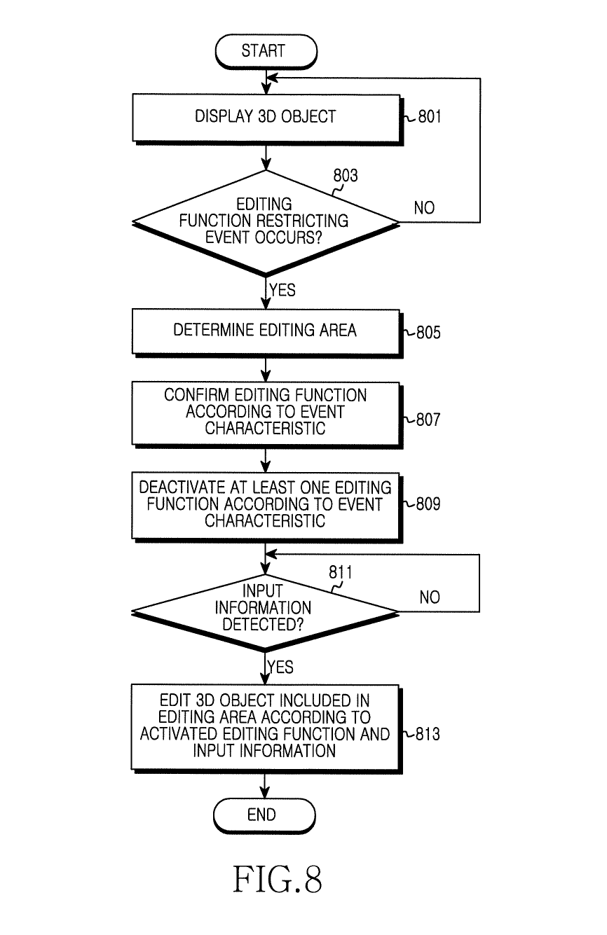

FIG. 8 is a flowchart illustrating an example procedure of editing at least one of 3D objects displayed on a display area in an electronic device according to this disclosure. Hereinafter, a procedure of editing a 3D object will be described with reference to FIGS. 9A to 9C.

Referring to FIG. 8, the electronic device may display a 3D object on the display unit 150 in operation 801. For example, when an application program for displaying a 3D object is run, the electronic device may display at least one 3D object 500 on the display unit 150 as illustrated in FIG. 5A.

When the 3D object is displayed, the electronic device may determine whether an editing function restricting event occurs in operation 803. For example, the electronic device may determine whether an editing function restricting menu is selected. For another example, the electronic device may determine whether selection of an editing function restricting icon is detected. For another example, the electronic device may determine whether a gesture of the electronic device for restricting an editing function is detected. For another example, the electronic device may determine whether a hardware button input for restricting an editing function is detected.

When the editing function restricting event does not occur, the electronic device may maintain the displaying of the 3D object in operation 801. If the editing function restricting event does not occur for a reference time, the electronic device may terminate the present algorithm.

When the editing function restricting event occurs, the electronic device may determine an editing area in operation 805. For example, the electronic device may determine an area 900 for editing the 3D object on the display unit 150 on the basis of the input information received through the input unit 160, as illustrated in FIG. 9A. Here, the electronic device may display the 3D object included in the editing area so that the 3D object included in the editing area is differentiated from another 3D object not included in the editing area, as illustrated in FIG. 9B.

The electronic device may identify at least one editing function to be deactivated on the basis of the event characteristic in operation 807. For example, when the editing function restricting event occurs, the electronic device may display an editing function list for the 3D object. Here, the electronic device may determine an editing function selected on the basis of the input information received through the input unit 160 as an editing function to be deactivated from among editing functions of the editing function list. For another example, when a first editing function restricting icon is selected from among editing function restricting icons displayed on the display unit 150, the electronic device may determine at least one editing function mapped to the first editing function restricting icon as an editing function to be deactivated. For another example, when a first gesture of the electronic device for restricting an editing function is detected, the electronic device may determine at least one editing function mapped to the first gesture as an editing function to be deactivated. For another example, when a hardware button input for restricting an editing function is detected, the electronic device may determine at least one editing function mapped to the detected hardware button input as an editing function to be deactivated.

The electronic device may deactivate at least one editing function according to the event characteristic in operation 809.

When at least one editing function is deactivated, the electronic device may determine whether the input information is detected through the input unit 160 in operation 811. That is, the electronic device may determine whether a user input for editing a 3D object is detected through the input unit 160.

When the input for editing a 3D object is detected, the electronic device may edit the 3D object displayed on the display unit 150 on the basis of an activated editing function and the input information in operation 813. For example, when the object rotating function is activated, as illustrated in FIG. 9C, the electronic device rotates (920) the 3D object included in the editing area 900 in the same direction as that of the touch input 910 illustrated in FIG. 9B.

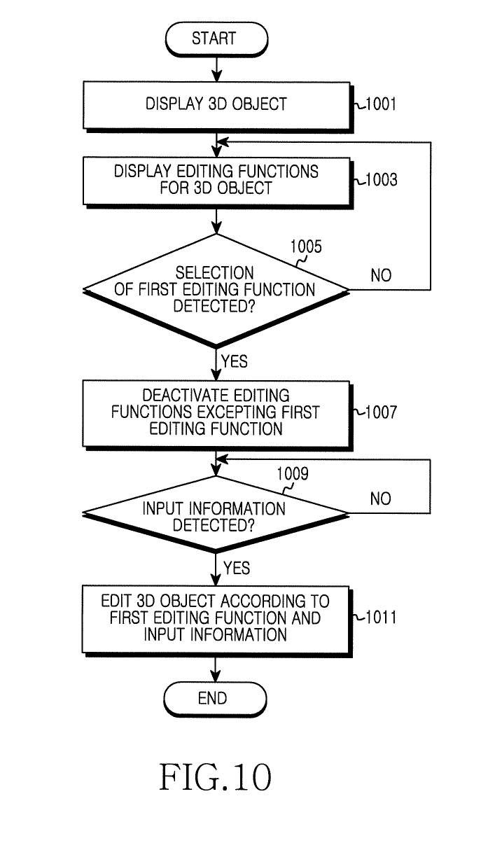

FIG. 10 is a flowchart illustrating an example procedure of inactivating at least one editing function in an electronic device according to this disclosure. Hereinafter, a procedure of editing a 3D object will be described with reference to FIGS. 11A to 11D.

Referring to FIG. 10, the electronic device may display a 3D object on the display unit 150 in operation 1001. For example, when an application program for displaying a 3D object is run, the electronic device may display at least one 3D object 500 on the display unit 150 as illustrated in FIG. 5A.

The electronic device may display, on the display unit 150, at least one editing function for the 3D object in operation 1003. For example, when an editing event for the 3D object occurs, the electronic device may display editing functions icons for the 3D object such as an object rotating icon 1100, a camera moving icon 1102, an object magnifying icon 1104, an object reducing icon 1106, and an object moving icon 1108 as illustrated in FIG. 11A.

When at least one editing function for the 3D object is displayed, the electronic device may determine whether selection of a first editing function is detected in operation 1005. For example, the electronic device may determine whether selection of at least one editing function icon from among the editing function icons displayed on the display unit 150 is detected as illustrated in FIG. 11A.

When the selection of an editing function is not detected, the electronic device may maintain the displaying of at least one editing function in operation 1003. If the selection of at least one editing function does not occur for a reference time, the electronic device may terminate the present algorithm.

When the selection of an editing function is detected, the electronic device may deactivate the editing functions for the 3D object excepting the selected first editing function in operation 1007. For example, when the selection of the objection rotating function 1100 is detected (1110) as illustrated in FIG. 11B, the electronic device may deactivate the editing functions excepting the objection rotating function 1100. Here, the electronic device may display the selected object rotating function 1100 so that the object rotating function 1100 is differentiated from the other editing functions as illustrated in FIG. 11C.

The electronic device may determine whether input information is detected through the input unit 160 in operation 1009. That is, the electronic device may determine whether a user input for editing a 3D object is detected through the input unit 160.

When the input for editing a 3D object is detected, the electronic device may edit the 3D object displayed on the display unit 150 on the basis of the first editing function and the input information in operation 1011. For example, when the object rotating function 1100 is activated, as illustrated in FIG. 11D, the electronic device rotate (1130) the 3D object displayed on the display unit 150 in the same direction as that of the touch input 1120 illustrated in FIG. 11C.

In the above-mentioned embodiment, at least one editing function may be deactivated excepting at least one selected editing function. Here, when the editing function activating event occurs, the electronic device may activate the deactivated editing function. For example, when at least one activated editing function is selected again, the electronic device may recognize that the editing function activating event has occurred so as to activate the deactivated editing function. For another example, when the 3D object is edited using the activated editing function, the electronic device may recognize that the editing function activating event has occurred so as to activate the deactivated editing function. For another example, the electronic device may determine whether an editing function activating menu is selected. For another example, the electronic device may determine whether selection of an editing function activating icon is detected. For another example, the electronic device may determine whether a gesture of the electronic device for activating an editing function is detected. For another example, the electronic device may determine whether a hardware button input for activating an editing function is detected.

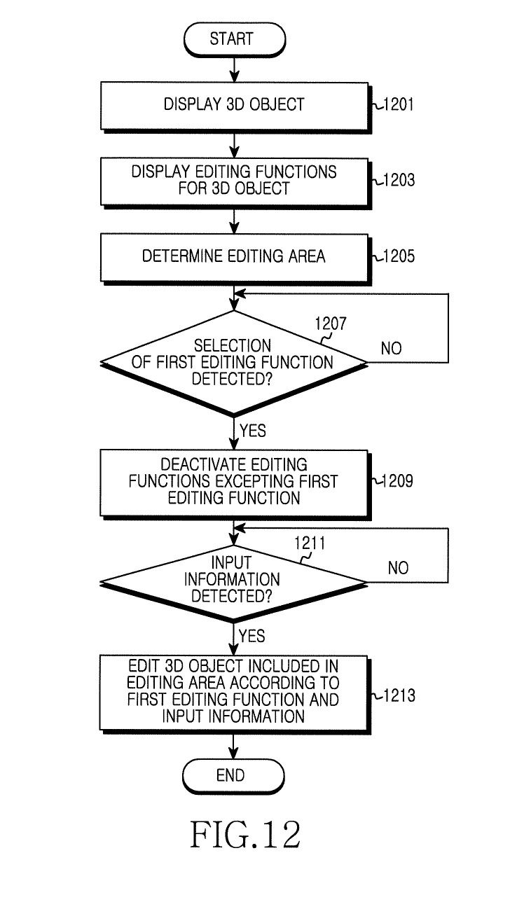

FIG. 12 is a flowchart illustrating an example procedure of editing at least one of 3D objects displayed on a display area in an electronic device according to this disclosure. Hereinafter, a procedure of editing a 3D object will be described with reference to FIGS. 13A to 13D.

Referring to FIG. 12, the electronic device may display a 3D object on the display unit 150 in operation 1201. For example, when an application program for displaying a 3D object is run, the electronic device may display at least one 3D object 500 on the display unit 150 as illustrated in FIG. 5A.

The electronic device may display, on the display unit 150, at least one editing function for the 3D object in operation 1203. For example, when an editing event for the 3D object occurs, the electronic device may display editing functions icons for the 3D object such as the object rotating icon 1100, the camera moving icon 1102, the object magnifying icon 1104, the object reducing icon 1106, and the object moving icon 1108 as illustrated in FIG. 11A.

When at least one editing function for the 3D object is displayed, the electronic device may determine an editing area in operation 1205. For example, the electronic device may determine an area 1300 for editing the 3D object on the display unit 150 on the basis of the input information received through the input unit 160, as illustrated in FIG. 13A. Here, the electronic device may display the 3D object included in the editing area so that the 3D object included in the editing area is differentiated from another 3D object not included in the editing area, as illustrated in FIG. 13B.

The electronic device may determine whether selection of a first editing function is detected in operation 1207. For example, the electronic device may determine whether selection of at least one editing function icon from among the editing function icons displayed on the display unit 150 is detected as illustrated in FIG. 13B.

When the selection of an editing function is not detected, the electronic device may continuously determine whether the selection of an editing function is detected in operation 1207. If the selection of at least one editing function does not occur for a reference time, the electronic device may terminate the present algorithm.

When the selection of an editing function is detected, the electronic device may deactivate the editing functions for the 3D object excepting the selected first editing function in operation 1209. For example, when the selection of the objection rotating function is detected (1310) as illustrated in FIG. 13B, the electronic device may deactivate the editing functions excepting the objection rotating function. Here, the electronic device may display the selected object rotating function so that the object rotating function is differentiated from the other editing functions as illustrated in FIG. 13C.

The electronic device may determine whether input information is detected through the input unit 160 in operation 1211. That is, the electronic device may determine whether a user input for editing a 3D object is detected through the input unit 160.

When the input for editing a 3D object is detected, the electronic device may edit the 3D object displayed on the display unit 150 on the basis of the first editing function and the input information in operation 1213. For example, when the object rotating function is activated, as illustrated in FIG. 13D, the electronic device may rotate (1330) the 3D object included in the editing area 1300 in the same direction as that of the touch input 1320 illustrated in FIG. 13C.

The methods according to the embodiments disclosed in the claims or the description of the present disclosure may be implemented in the form of hardware, software or a combination thereof.

In the case of implementation by software, a computer-readable recording medium for storing at least one program (software module) may be provided. The at least one program stored in the computer-readable storage medium is configured so as to be executed by at least one processor in an electronic device. The at least one program includes instructions for instructing the electronic device to perform the methods according to the embodiments disclosed in the claims or the description of the present disclosure.

Such a program (software module or software) may be stored in a random access memory, a non-volatile memory including a flash memory, a read-only memory (ROM), an electrically erasable programmable ROM (EEPROM), a magnetic disk storage device, a compact disk ROM (CD-ROM), a digital versatile disk (DVD), another type of an optical storage device, and a magnetic cassette. Alternatively, such a program may be stored in a memory configured with a combination of some or all of the above-mentioned storage devices. Furthermore, each memory may be provided in plurality.

Furthermore, such a program may be stored in an attachable storage device that may access the electronic device via a communication network such as the Internet, an intranet, a local area network (LAN), a wide LAN (WLAN) or a storage area network (SAN) or a communication network configured with a combination thereof. Such a storage device may be connected to the electronic device through an external port.

Furthermore, an additional storage device on a communication network may be connected to the electronic device.

As described above, in a mobile electronic device, at least one of editing functions for editing a 3D object displayed on a display area is deactivated to limit editing functions applicable to the 3D object, thereby reducing an error of editing the 3D object.

While the disclosure has been shown and described with reference to certain preferred embodiments thereof, it will be understood by those skilled in the art that various changes in form and details may be made therein without departing from the spirit and scope of the disclosure as defined by the appended claims. Therefore, the scope of the disclosure is defined not by the detailed description of the disclosure but by the appended claims, and all differences within the scope will be construed as being included in the present disclosure.

What is claimed is:

1. A method in electronic device, comprising:
displaying a 3D object;
deactivating at least one of a plurality of editing functions for the displayed 3D object; and
editing the displayed 3D object using an editing function activated on the basis of input information.

2. The method of claim 1, wherein the editing function comprises at least one of object resizing, object moving, camera shooting direction changing, and object rotating.

3. The method of claim 1, wherein deactivating at least one of the editing functions comprises:
identifying at least one editing function mapped to a first event when the first event occurs; and
deactivating the at least one editing function mapped to the first event from among the editing functions for the displayed 3D object.

4. The method of claim 3, wherein the identifying the at least one editing function comprises identifying the at least one editing function mapped to the first event when at least one of selection of an editing function restricting menu, selection of an editing function restricting icon, detection of an editing function restricting gesture and hardware button input occurs as the first event.

5. The method of claim 3, further comprising activating the at least one editing function mapped to the first event when the first event occurs again.

6. The method of claim 1, wherein deactivating the at least one of the editing functions comprises:
displaying the editing functions for the displayed 3D object; and
deactivating, when selection of at least one editing function from among the displayed editing functions is detected, the editing functions excepting the selected at least one editing function.

7. The method of claim 1, further comprising:
determining an editing area in a display area where the 3D object is displayed, before displaying the 3D object, wherein editing the 3D object comprises editing the 3D object included in the editing area using the editing function activated on the basis of the input information.

8. The method according to claim 7, wherein the determining the editing area comprises determining the editing area on the displayed 3D object on the basis of touch information on the displayed 3D object.

9. The method of claim 1, further comprising activating the at least one deactivated editing function after editing the 3D object.

10. An electronic device comprising:
an input unit;
a display unit configured to display a 3D object; and
a processor configured to deactivate at least one of a plurality of editing functions for the 3D object displayed on the display unit, and edit the 3D object displayed on the display unit using an editing function activated on the basis of input information detected through the input unit.

11. The electronic device of claim 10, wherein the editing function comprises at least one of object resizing, object moving, camera shooting direction changing, and object rotating.

12. The electronic device of claim 10, wherein the processor comprises:
an editing control unit configured to deactivate at least one of the editing functions for the 3D object displayed on the display unit; and
a display control unit configured to edit the 3D object displayed on the display unit using the editing function activated on the basis of the input information detected through the input unit.

13. The electronic device of claim 12, wherein the editing control unit identifies at least one editing function mapped to a first event when the first event occurs, and deactivates the at least one editing function mapped to the first event from among the editing functions for the displayed 3D object.

14. The electronic device of claim 13, further comprising:
a memory configured to store at least one editing function mapped to an event, wherein the editing control unit is configured to identify the at least one editing function mapped to the first event when at least one of selection of an editing function restricting menu, selection of an editing function restricting icon, detection of an editing function restricting gesture and hardware button input occurs as the first event.

15. The electronic device of claim 13, wherein the editing control unit is configured to activate the at least one editing function mapped to the first event when the first event occurs again.

16. The electronic device of claim 12, wherein the editing control unit is configured to display the editing functions for the 3D object displayed on the display unit, and deactivate, when selection of at least one editing function from among the displayed editing functions is detected, the editing functions excepting the selected at least one editing function.

17. The electronic device of claim 12, wherein the editing control unit is configured to determine an editing area on the display unit, and
the display control unit is configured to edit the 3D object included in the editing area using the editing function activated on the basis of the input information detected through the input unit.

18. The electronic device of claim 12, wherein, when the 3D object is edited using at least one activated editing function in the display control unit, the editing control unit is configured to activate the at least one deactivate editing function.

19. The electronic device of claim 10, wherein the electronic device comprises at least one of a smartphone, a tablet personal computer (PC), a mobile phone, a video phone, an electronic book reader, a desktop PC, a laptop PC, a netbook computer, a personal digital assistant (PDA), a portable multimedia player (PMP), an MP3 player, and a mobile medical device.

20. The method of claim 1, wherein the electronic device comprises at least one of a smartphone, a tablet personal computer (PC), a mobile phone, a video phone, an electronic book reader, a desktop PC, a laptop PC, a netbook computer, a personal digital assistant (PDA), a portable multimedia player (PMP), an MP3 player, and a mobile medical device.
